(19) United States
(12) Patent Application Publication
(10) Pub. No.: US 2002/0083411 A1
(43) Pub. Date: Jun. 27, 2002

(54) Terminal-based method for optimizing data lookup

(76) Inventors: Nicolas Bouthors, Meylan (FR); Frederic Grardel, St. Egreve (FR)

Correspondence Address: Robert M. Angus, Westman, Champlin & Kelly, International Centre, Suite 1600, 900 Second Avenue South, Minneapolis, MN, 55402-3319, US

(21) Appl. No.: 09/965,674

(22) Filed: Sep. 27, 2001

(30) Foreign Application Priority Data
Sep. 29, 2000 (FR) 00 12486

(51) Int. Cl. G06F 9/44

(52) U.S. Cl. 717/100

(57) ABSTRACT

The invention relates to a method for optimizing the looking up of a page (200) of data looked-up on a terminal (100) by at least one user. The looked-up data are downloaded from a first remote site (103, 104, 105) and/or are available on a data medium. The method comprises a step for inserting (302, 402) on the fly at least one active code into the page (200) by means of a terminal (100).

### FIELD OF THE INVENTION

The field of the invention is that of looking up data on a client terminal, such as notably, a radiotelephone, a mobile terminal or a microcomputer, wherein these data stem from a communications network.

More specifically, the invention relates to the optimization of data set lookups by a terminal user and in particular to the adaptation of these data to this particular user.

### BACKGROUND OF THE INVENTION

The invention is applied to the case when looked-up data are downloaded from a communications network to a terminal and/or are available on a removable medium.

The communications network may notably, but not exclusively be a network of the internet type, such as the global Internet network. In this case, data are downloaded from access links which are destination addresses (or URL (Uniform Resource Locator) addresses), to pages of information (or Web pages).

In addition, the present invention is not only applied when the terminal directly accesses the communications network, but also when it accesses it via at least one other telecommunications network, to which it is subscribed. This other telecommunications network is for example the switched telephone network (“fixed network”) and/or a radiocommunications network (“mobile network”).

In the case of a radiocommunications network, the latter uses for example the GSM (“Global System for Mobile communications”) standard or an equivalent or rival standard such as DCS 1800 (Digital Cellular at 1800 MHz), PCS 1900 (Personal Communication System at 1900 MHz), DECT (Digital European Cordless Telecommunications), GPRS (General Packet Radio Service) or UMTS (Universal Mobile Telecommunications System).

In order to show the drawbacks of the prior art, in terms of looked-up data, a reminder will now be given on the principles of the present technique for looking up data from a Web page, within the Internet network. Conventionally, a Web page may either be associated with a site (home page) or with a portion of a site (other site page(s)). Optionally, each Web page may also correspond to a service of a site.

It is clear that the drawbacks which will be described by means of an illustrative example, are common to other techniques for looking up data, from the prior art.

It is assumed that the considered client accesses a telecommunications network interconnected with the Internet network. Via his/her terminal (or “network equipment”), he/she makes a request for connecting to the Internet network to his/her access provider who then undertakes to provide a communication between the client terminal and the Internet network. After this communication is established, the client may access different Web pages, according to a client/server mode. For this, a client software comprised in his/her terminal, i.e. a navigator (or browser) is available which notably has a direct operating mode and an indirect operating mode.

In the direct operating mode, the navigator uses URL addresses, known to the user and directly given to the navigator by the user.

In the indirect operating mode, the navigator uses hypertext links (or hyperlinks) contained in another Web page, displayed on the screen of the terminal. Each hyperlink comprises a URL address on the one hand and a hypertext link area (image and/or text) contained in the Web page displayed on the screen of the terminal.

The URL address of a page has typically the following form:

“http://www.mysite.com/mypage.htlm” wherein:

“http” identifies the protocol used;

“www.mysite.com” represents the page server; and

“mypage.html” characterizes the page itself.

After the client has provided a URL address, by entering it directly (direct mode) or indirectly by clicking on a hypertext link area corresponding to a Web page of his choice (indirect mode), the navigator detects the protocol used (“http”), the page server (“www.mysite.com”) and the page to be requested (“mypage.html”). Next, it connects to the server and transmits a http (Hypertext Transfer Protocol) request to it, a hypertext transfer protocol currently used on the Internet network and specified in the RFC2616 and RFC2617 standards published by IETF and available on the http://www.ietf.org/rfc/ site, requesting the content of the specified page. In both cases, this is referred to as an activation of the access link formed by the URL address.

This request is received by the server containing the sought-after Web page (i.e. the one with the provided URL address), so that, on return, this Web page is dispatched by the server on the network, through a HTTP (Hypertext Transfer Protocol) connection. Generally, the content of the Web page is described in a page description language HTML (Hypertext Markup Language) or a language with hypertext markers specified in the RFC1866 and RFC2854 standards as defined by IETF and available on site http://www.ertf.org/rfc or in the ISO/445 15445 standard as defined by ISO/IEC). This language contains instructions (tags) telling the navigator of the client terminal how to organize the Web page upon its arrival.

The conventional use of URL addresses as described above, has several drawbacks and is unable to meet all requirements.

First of all, presentation of the information is carried out according to criteria specific to the author of the looked-up data pages and does not take into account the requirements of the client.

Further, the conventional use of URL addresses does not allow filtering of client relevant data to be performed automatically or on the contrary censuring of certain data.

Moreover, conventional use of URL addresses does not allow a Web service to be provided permanently, whatever the accessed site.

For that matter, conventional use of URL addresses does not allow advertising to be inserted in Web pages during the access.

The object of the invention is notably to overcome these various drawbacks of the state of the art.

More specifically, one of the objects of the present invention is to provide a technique for looking up data present on a communications network, enriched and adapted to each client (or at least certain clients).

Another object of the invention is to provide a client with selected data for this client according to his/her needs, choices, indications.

The object of the invention is also to take into account the looked-up data in order to provide relevant complementary data on the fly.

The object of the invention is also to provide such a technique which is simple to implement and not very costly.

Yet another further object of the invention is to enable an Internet site operator or manager to provide a service with high added value.

Another object of the invention is to enable an Internet service to be provided permanently, whatever the accessed site.

An object of the invention is also to enable targeted complementary data, notably advertising data, to be inserted into Internet pages when they are accessed.

### SUMMARY OF THE INVENTION

These different objects as well as others which will be apparent subsequently, are achieved according to the invention by means of a method for optimizing the looking up of a page of data looked up on a terminal by at least one user, the looked-up data being downloaded from a first remote site and/or available on a data medium, remarkable in that it comprises a step for inserting on the fly at least one active code into the page by means of the terminal.

It is noted that an active code is a code which enables an algorithm and/or instructions to be executed by the terminal of the user.

It is also noted that the data medium may be a fixed data medium (such as notably a hard disk, a memory) or a removable one (such as notably a diskette, a CD-ROM, a DVD-ROM . . . )

Thus, the invention has applications which notably allow the content provided by the first remote site and/or available on a data medium to be enriched by providing it notably with complementary information or services, without generally inflicting a penalty on the access times to the remote site and/or to the data medium.

According to a particular feature, the optimization method is remarkable in that the area of the page wherein the active code is inserted, is determined according to the type of action generated by the active code.

Thus, the insertion of an active code in a specific area of the page of data may be particularly well adapted to certain applications:

insertion of active code at the beginning of the page for example, is well adapted to applications of the type for censuring certain data or for limiting access to URLs present in the data;

insertion of active code at the end of the page for example, is well adapted to applications of the targeted advertising type.

According to a particular feature, the optimization method is remarkable in that the active code inserted on the fly is a final active code enabling an algorithm to be executed on the terminal.

According to a particular feature, the optimization method is remarkable in that the active code inserted on the fly is an intermediate invocation active code which, when it is executed by the terminal, enables the terminal to invoke a provider of the final active code, so that the terminal receives from the latter a final specific active code enabling an algorithm to be executed on the terminal.

Thus, the invention advantageously enables two types of different active codes to be taken into account:

an active code directly executing a final algorithm on the terminal; or

an intermediate active code invoking a final active code which will be executed on the terminal.

Both of these types of active code are of interest. The active code directly executed on the terminal may directly be utilized by the terminal whereas the intermediate active code may notably be more easily customized than a directly executed active code.

According to a particular feature, the optimization method is remarkable in that when the provider of the final active code is invoked by the terminal, the terminal provides at least one cookie in addition.

A cookie is an Internet mechanism which enables site developers to place information in the terminal for subsequent use. A cookie notably is a memory or a storage unit which enables information to be stored in hexadecimal form. A navigator executing on the terminal stores the cookies which it has received from a site and has them available for script codes included in the pages of this site, or transmits them to the Web server of the site simultaneously with the request for contents when the requested page is the result of an executable.

Thus, the delivered cookie may advantageously be used by an active code transmitted by the site having delivered the cookie or by this site for delivering a customized active code.

According to a particular feature, the optimization method is remarkable in that it further comprises at least one step preceding the on-the-fly insertion step and belonging to the group comprising:

the steps for defining a profile of the user of the terminal;

the steps for generating said at least one cookie depending on the profile of the user of the terminal;

the steps for providing said at least one cookie to the terminal by the provider of the final active code, and

the steps for storing said at least one cookie by the terminal.

According to a particular feature, the optimization method is remarkable in that said at least one cookie is used for identification purposes.

According to a particular feature, the optimization method is remarkable in that the provider of the final active code takes the contents of said at least one cookie into account for generating the specific final active code.

Thus, advantageously, the invention enables a user to define a profile upon preliminary access to the provider of the final active code, wherein this profile may notably contain information for identifying the user, information giving his/her preferences (information which particularly are of interest to him/her or on the contrary which he/she does not desire, mode for presenting information . . . ). As this profile is stored as a cookie connected with the provider of the final active code, the final script may either use the information from the cookie on the terminal, or be generated according to this information after delivering the cookie to the provider of the final active code.

According to a particular feature, the optimization method is remarkable in that the active code belongs to the group comprising:

script codes interpreted by a navigator;

“includes” of the script code interpreted by a navigator;

navigator objects;

codes exploiting navigator objects;

applets;

codes exploiting applets; and

macro-instructions.

Thus, the invention takes into account the numerous alternatives of active code which exist, notably:

script codes which are sequences of instructions, notably used for handling, customizing and automating certain tasks provided by the terminal; there are several languages for writing script codes (specifications of a script language example are available in the document “ECMAScript Language Specification” published by the ECMA and available on the http://www.ecma.ch site. Other script languages notably exist, the JavaScript® languages developed by Netscape® and Jscript® developed by Microsoft®);

“includes” of script codes (or external script code) which characterize the instructions for including script codes, supported by the language used during the exchanges (the term “include” is a term used in languages supporting script codes);

navigator objects such as notably ActiveX® which are navigator objects added dynamically within the scope of operating systems developed by Microsoft® such as Windows®;

codes exploiting navigator objects which indirectly invoke at least one navigator object function;

applets which are small applications developed in Java language invoked by an Internet page, downloaded and executed by the terminal and which control access to resources;

codes exploiting applets which indirectly invoke one or several applet functions;

macro-instructions which are sequences of instructions which may notably be used in software packages running on the terminal such as for example, word processing, graphics, spreadsheet software packages.

Advantageously, with the invention, it is possible to make the most out of the terminal according to the targeted application.

According to a particular feature, the optimization method is remarkable in that the active code inserted in the page is loaded and/or interpreted and/or executed by the terminal before, during and/or after displaying the page on the terminal.

Thus, according to the type of application, the active code will advantageously be executed before, during and/or after displaying the page, notably according to the type of application.

According to a particular feature, the optimization method is remarkable in that the active code is executed in a navigator comprised in the terminal.

According to a particular feature, the optimization method is remarkable in that the active code is specifically generated according to at least one criterion specific to a component belonging to the group comprising:

said at least one user of the terminal;

the terminal;

the first remote site;

the page;

the Internet access provider enabling the terminal to access the first remote site; and

the navigator used by the terminal.

According to a particular feature, the optimization method is remarkable in that said at least one criterion belongs to the group comprising:

the identity of said at least one user of the terminal;

the preferences of said at least one user of the terminal;

the address and/or the domain name of the first remote site;

the origin of the looked-up data;

the type and/or the version of the navigator used by the terminal;

the type and/or the version of the terminal;

the provider of the looked-up data; and

the type of access to the looked-up data.

Thus, the invention advantageously enables the active codes to be customized according to very different criteria which may notably comprise the following criteria:

the user and his/her preferences which may notably be identified by a cookie;

the addresses of the downloaded page and its site, notably the URL addresses (Uniform Resource Locator addresses which specify without any ambiguity the physical location of the page and site)

the type and version of the navigator which are direct pieces of information transmitted by the navigator;

the type and version of the terminal which are indirect pieces of information transmitted by the navigator;

the transfer protocol which may notably be of the HTTP, FTP, POP, IMAP, RSTP type; and

the Internet access or service provider (ISP/IAP) which may be identified by its addressing range.

According to a particular feature, the optimization method is remarkable in that it is used for at least one application belonging to the group:

insertion of information into the page;

insertion into the page, of information relating to events handled by a second remote site connected to the terminal;

insertion into the page, of information relating to data available on a portal in relationship with the content of the page;

provision to the user, via the page, of at least one service provided by at least a third remote site connected to the terminal;

archiving of information related to the activity of the user of the terminal;

change in the presentation of the data;

censure of at least one datum among the data; and

invocation of at least one second active code.

Thus, the invention advantageously enables numerous applications to be implemented, which are not directly handled by the first remote site.

According to a particular feature, the optimization method is remarkable in that it is used for at least one application of the insertion type in the page of additional information and in that the active code implements the following operations:

search for at least one specific piece of information in the page;

creation of a list of specific pieces of information found in the page;

creation of an area for inserting additional pieces of information into the page;

provision of the list of specific pieces of information to a provider of additional information connected to the network; and

filling the area for inserting additional information with data provided by the provider of information in response to the operation providing the list of specific pieces of information.

According to a particular feature, the optimization method is remarkable in that the additional pieces of information belong to the group comprising:

advertising information;

annotations;

complementary links to remote sites dealing with the same subject as the looked-up data;

complementary links to remote sites dealing with subjects closely related to the looked-up data;

alternative keywords;

notes assigned to the first remote site; and

indexation tables for the items of the looked-up data page.

Thus, the invention advantageously enables pieces of information, notably of the annotation types, which may be of high added value, if for example they are transmitted by third parties independent of the provider of looked-up data, and/or alternative keywords (notably synonyms or associations enabling for example an appropriate and/or specific search to be launched over Internet) and/or indexation tables providing fast access to the page to be added.

According to a particular feature, the optimization method is remarkable in that it is used for at least one application for changing the presentation of data; and in that the active code implements the following operations:

search for at least one specific piece of information in the page;

creation of a list of specific pieces of information found in the page;

providing the list of specific pieces of information to an information provider connected to the terminal; and

presentation of at least one portion of the downloaded data according to a format defined by the information provider in response to the operation providing the list of specific pieces of information.

Thus, the invention advantageously enables the contents of the data not only to be enriched but also the form to be enriched by redefining if necessary the format of these data in order to enhance certain portions or on the contrary make them less conspicuous according to any criteria.

According to a particular feature, the optimization method is remarkable in that it is used for at least one application for censuring at least one datum among the data, and in that the active code implements the following operations:

search for a least one specific piece of information in the page;

creation of a list of specific pieces of information found in the page;

provision of the list of specific pieces of information to an information provider connected to the network; and

censure of at least one portion of the data according to at least one criterion defined by the information provider in response to the operation providing the list of specific pieces of information.

Thus, the invention advantageously enables the display of certain data to be prevented because they notably may not be desired by the user or be unauthorized for the user according to his/her profile.

According to a particular feature, the optimization method is remarkable in that it is used for at least one application for invoking at least one second active code, and in that the active code implements the following operations:

search for a least one specific piece of information in the page;

creation of a list of specific information found in the page;

provision of the list of specific pieces of information to an information provider connected to the terminal; and

invocation of at least one second active code according to at least one criterion defined by the information provider in response to the operation providing the list of specific pieces of information.

Thus, the invention advantageously enables a second active code, notably customized according to the data to be provided.

According to a particular feature, the optimization method is remarkable in that said at least one specific piece of information belongs to the group of pieces of information comprising:

the keywords;

the addresses of the links;

the addresses of the items mentioned in the page and

the information for creating the page.

Thus, the active code advantageously depends on the items related to the data, notably items mentioned in the page which for example are images and/or information for creation of the page, which notably are its author, the creation date and the company to which belongs its author.

According to a particular feature, the optimization method is remarkable in that said at least one specific piece of information is updated according to a predetermined criterion.

According to a particular feature, the optimization method is remarkable in that the predetermined criterion belongs to a group of criteria comprising:

the identity of said at least one user of the terminal;

the preferences of said at least one user of the terminal;

the address and/or the name of the domain of the first remote site;

the origin of the looked-up data;

the type and/or the version of the navigator used by the terminal;

the type and/or the version of the terminal;

the provider of the looked-up data

the type of access to the looked-up data; and

the Internet access provider enabling the terminal to access the first remote site.

Thus, the active code, advantageously depends not only on the items related to the data, but also on items related to the terminal, to its user or to the Internet access provider.

According to a particular feature, the optimization method is remarkable in that it is used for at least one application of the type for permanently providing the user, via the page, with at least one service provided by at least one fourth remote site connected to the network, and in that the active code, upon its execution by the terminal, declares said at least one service in the page.

The declaration of the service in the page means that the active code makes the service accessible when the page is downloaded on the terminal by associating it with an event for example.

According to a particular feature, the optimization method is remarkable in that the code enables a menu for accessing the service to be implemented by the terminal.

According to a particular feature, the optimization method is remarkable in that said at least one service belongs to the group comprising:

simplified services for accessing information other than that contained in the page;

simplified services for accessing search engines;

simplified services for accessing advanced functions of a navigator comprised within the terminal;

services for monitoring external events; and

simplified accesses to at least one service available on the Internet by hand and which requires at least that data be entered.

Thus, in an advantageous embodiment of the invention, insertion of active code on the fly enables simplified accesses to services related:

to the detection and exploitation of a selection (selection of a word, of a group of words, of an image, of a link...) by means of a mouse connected to the terminal; and/or

to the simplicity for triggering the service (contextual menu or mouse double-click)

Insertion of active code on the fly further enables services available by hand on the Internet to be accessed and this requires at least that data be entered (notably words, sentences, URL addresses), as for example:

search for Web content (broadly speaking, site engines);

search for prices or services on the Web (price comparison engine, professional reference library, . . . )

search for meanings (encyclopedias); and

multilanguage translation (dictionaries, sentence translation automata).

The notion of “monitoring external events” is connected with the customization of active code made by an active code server. Indeed, it is possible to produce a code which generates an alarm message every time an event must be transmitted to the identified user (through a cookie) (for example, an external event is the arrival of an e-mail on the e-mail account of the user on a portal, when he/she is navigating on a site other than the portal).

The monitoring of external events notably enables a code to be produced for generating an alarm message every time an event must be transmitted to the identified user (through a cookie).

According to a particular feature, the optimization method is remarkable in that said at least one service is attached to at least one event belonging to the group comprising:

actions on a man-machine interface; and

navigation events.

Thus, advantageously, an active code may thereby be associated with actions on a mouse controlling the terminal (notably the right clicks (causing a contextual menu to be displayed), the double-click, the displacement of a pointer controlled by the mouse in or out of an area of the screen), with actions on one or several keys of the keyboard, with combined actions on the mouse and at least one key of the keyboard (notably, chainings and synchronization of several actions on the mouse and on at least one key of the keyboard), with actions on a sensitive screen, with voice control.

The icons are particularly of interest within the scope of mobile terminals, with a screen of very small size.

Moreover, the navigation events will notably be the beginnings and ends of loading pages, page outputs, loading errors, interpretation errors, execution errors.

According to a particular feature, the optimization method is remarkable in that said at least one service is attached to at least one marker language item.

The marker languages considered here are notably HTML (HyperText Mark-up Language), XML (extensible Mark-up Language), WML (Wireless Mark-up Language). The mark-up language items are notably a menu bar which may be hidden from view or icons superimposed on the terminal screen.

According to a particular feature, the optimization method is remarkable in that the data page consists of at least two subpages, the active code is included in each subpage.

Further the invention provides a remarkable system in that it comprises means suitable for implementing the insertion of active code as described earlier.

The invention further provides a device for optimizing the looking up of a page of data looked up on the device by at least one user, wherein the looked-up data are downloaded from a first remote site and/or are available on a data medium, remarkable in that it comprises means for inserting active code into the page, on the fly.

According to a particular feature, the optimization device is remarkable in that it belongs to the group comprising:

microcomputers;

terminals for looking up data on networks;

terminals for looking up data from a removable medium; and

mobile terminals.

The terminals for looking up data on a network relate to terminals notably connected broadly speaking to networks of the Internet type, (notably Web, WAP networks, . . . ).

Terminals for looking up data from a removable medium notably are terminals having a removable medium reader such as notably a diskette, a CD-ROM, a DVD-ROM.

Mobile terminals are notably terminals of the GSM, GPRS mobile types or third generation mobile types (notably UMTS, IMT2000).

As the particular features and advantages of the devices and of the system for inserting active code on the fly are the same as those of the method for inserting active code on the fly, they shall not be mentioned again herein.

### BRIEF DESCRIPTION OF THE DRAWINGS

Other features and advantages of the invention will become apparent upon reading the following description of a preferred embodiment of the invention, given as an indicative and non-limiting example, and of the appended drawings, wherein:

FIG. 1 schematically illustrates a network, according to the invention, in accordance with a particular embodiment;

FIG. 2 describes a page of source code after insertion of active code by a terminal, according to the invention, in accordance with a particular embodiment;

FIG. 3 shows a communications protocol with insertion of a script into a page of data by a terminal, according to the invention, in accordance with a particular embodiment;

FIG. 4 shows a communications protocol with insertion of an “include” of script code into a page of data by a terminal, according to the invention, in accordance with a particular embodiment;

FIG. 5 shows a communications protocol with insertion of an “include” of script code for an application of the advertising insertion type, according to the invention, in accordance with a particular embodiment;

FIG. 6 shows a communications protocol with insertion of an “include” of script code for an application of the type for permanently providing an Internet service, according to the invention, in accordance with a particular embodiment.

### DETAILED DESCRIPTION OF THE PREFERRED EMBODIMENTS

The general principle of the invention lies in the insertion of active code on the fly by a terminal into looked-up data on the terminal (such as for example, a microcomputer or radiotelephone, a wireless or mobile terminal notably of the GSM, GPRS or UMTS type).

The looked-up data may be downloaded from a network and/or available on a data medium (such as for example, a diskette, a CD-ROM, a DVD-ROM . . . ).

The network is notably a network of the Internet type.

The downloaded data are generally specified in a marked-up language such as for example the HTML, XML, WML languages.

When the terminal receives downloaded data, it inserts into the data an active code and sequentially executes the specified instructions including the active code.

This active code may assume several forms notably according to the type of application:

script codes interpreted by a navigator;

“includes” of script code interpreted by a navigator;

navigator objects;

codes exploiting navigator objects;

applets;

codes exploiting applets; and

macro-instructions.

The active code may be considered as final or intermediate code;

when active code is a final code, it does not resort to a script server when it executes on the terminal;

when the inserted active code is an intermediate invocation active code, when it is executed by the terminal, it enables the terminal to invoke a final active code notably on a script server, so that the terminal receives from the latter a final specific active code enabling an algorithm to be executed on the terminal. In this case, the final active code may make the most of a cookie connected with the script server and already present on the terminal by making use of the information provided by this cookie.

Generally, one or several cookies may be provided to the terminal during a first access to the script code server.

And then, as a result of a request for content, an intermediate invocation active code will be inserted into the content on the fly. This active code will cause a request for script code to the script code server, whereby the cookie(s) is(are) provided to the script code server at the same time as the request. The script server analyzes the received cookie(s), composes a script code depending on the received cookie(s) and transmits to the terminal the composed script code which is thus adapted to the user of the terminal, or even customized.

Among the major applications of the insertion of active code on the fly, the following may be mentioned:

insertion of customized annotations in the pages of looked-up data on the terminal; (notably the method may be used such as the one described in the Patent Application entitled “procédé et système de consultation de données” (Method and system for looking up data) filed on the same day as the present application by the same applicant. The text of the other application is herein inserted by reference).

insertion of targeted complementary data, notably advertising data into the pages of looked up data on the terminal;

provision of services easily accessible by the user which notably enable him/her to access (notably by a simple mouse click or by simply hitting function keys on the keyboard of the terminal) a preferential remote site.

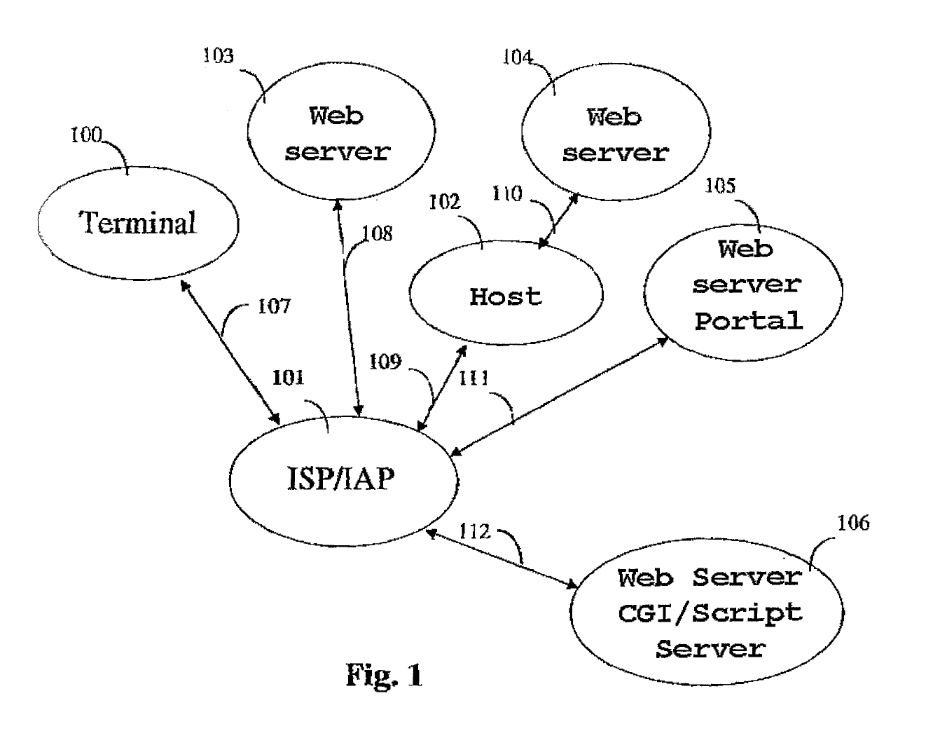

A telecommunications network infrastructure is shown in relationship with FIG. 1, which enables the invention to be implemented according to a preferred embodiment.

This infrastructure notably comprises:

a client terminal 100;

a piece of equipment 101 from a Internet Service Provider (ISP) or an Internet Access Provider (IAP);

a piece of equipment 102 from a host of Internet sites;

two Web site servers 103 and 104;

a Web site 105 providing a portal function; and

a Web site server 106 providing a script server and/or common gateway interface (CGI) function (the specifications of which are described on site http://hoo.ncsa.uiuc.edu/cgi/).

The client terminal 100 is of any type such as for example, a mobile terminal and/or computer.

The client terminal 100 may access via a link 107 a piece of equipment 101 of the Internet Service Provider (ISP) or Internet Access Provider (IAP) which notably enables it to download data.

The piece of equipment 101 of the Internet Service Provider (ISP) or of the Internet Access Provider (IAP) is connected to Web servers 103, 105 and 106 via links 108, 110 and 112, respectively.

The piece of equipment 101 of the Internet Service Provider (ISP) or of the Internet Access Provider (IAP) is further connected to the piece of equipment 102 of the Internet site host via a link 109.

The piece of equipment 102 of the Internet site host is itself connected to a Web server 104, via a link 110.

Links 107, 108, 109, 110, 111 and 112 are any communications links, notably links belonging to a switched telephone network (STN), links of the Internet type and/or links belonging to a radiocommunications networks (for example complying with the GSM standard, or another one).

Thus, the terminal 100 may access the contents of sites managed by any of the servers 103, 104, 105 or 106.

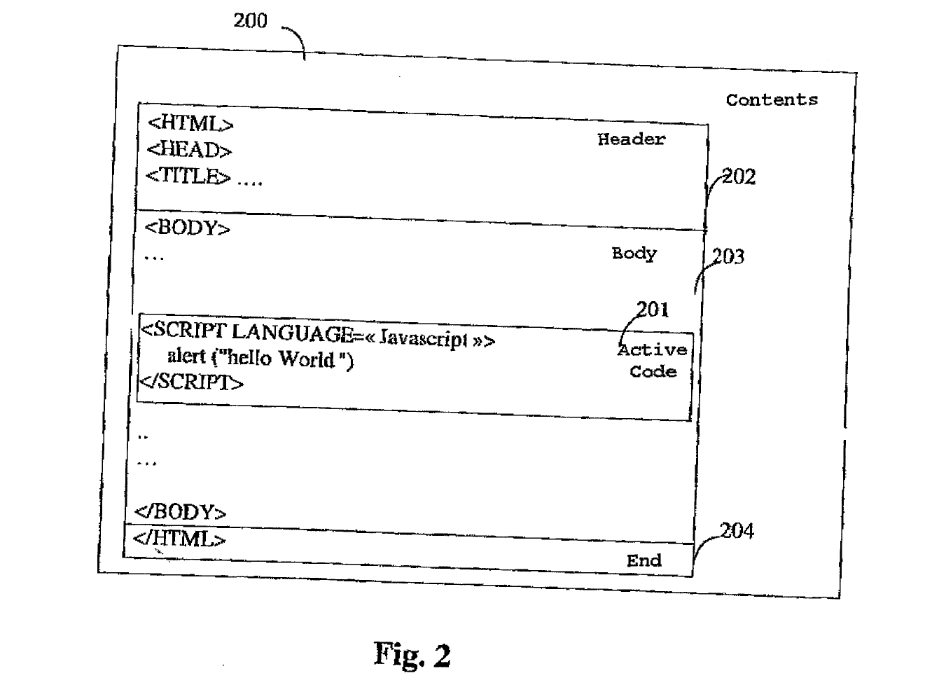

FIG. 2 schematically illustrates a page of source code 200 as shown on the screen of terminal 100 after insertion of an active code into a page of data provided by terminal 100.

It is noted that the page of contents 200 is a page of contents which is divided into three portions:

a header 202 notably containing instructions for identifying the language used (HTML here for example) and a page title,

a body 203 which notably contains information and an active code 201

a trailer 204 notably containing an HTML end-of-page instruction.

In the preferred embodiment, the active code is a Javascript code which starts by a marker indicating the beginning of a script and its type (“<SCRIPT LANGUAGE=Javascript”>”), which is followed by one or several specific instructions which will be executed on terminal 100 (for example, the opening of an alarm window containing a message “hello world” by means of the instruction alert(“hello world”)) and ends with a marker indicating the end of the script code (“</SCRIPT>”).

It is noted that a script code notably contains:

one or several instructions which are sequentially interpreted and executed:

and optionally

one or several functions which may be called upon executing the script code or as a result of an event handled by an application such as a navigator.

As a first alternative, the script code is not placed within the body 203 of the contents 200, but in its header 202 or in the trailer 204. It may also be placed outside the HTML areas while remaining within the contents 200 provided to the terminal 100.

As a second alternative, several active codes corresponding to the same application or not are inserted in the contents 200.

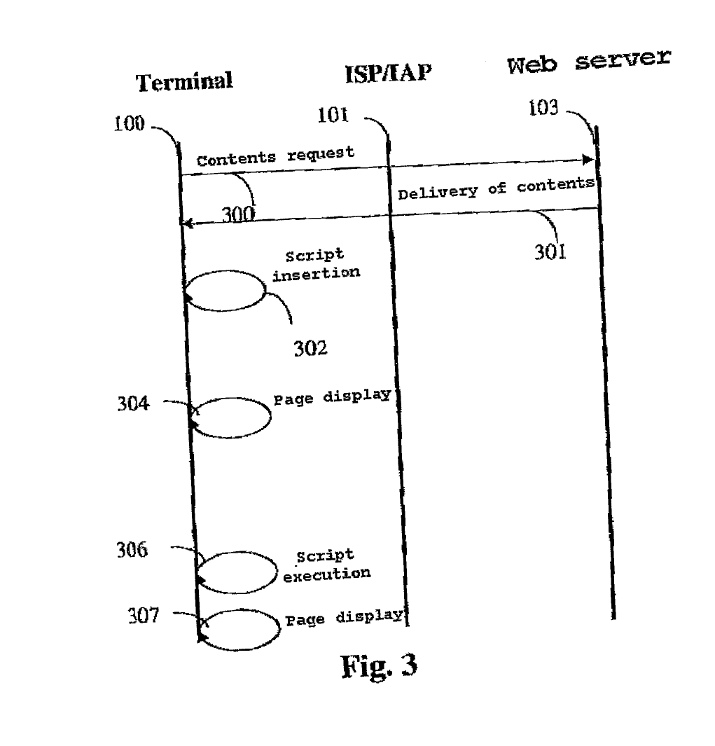

FIG. 3 shows a communications protocol with insertion of a script into a page of data by an Internet Service Provider 101.

As a result of the terminal 100 looking up 300 the site of Web site server 103 via the access provider 101, the server 103 delivers a content to the access provider 101 during a step for delivering the content 301.

Then, during a step 302 for inserting the script, the terminal 100 inserts a script 201 as described with reference to FIG. 2, into the delivered content.

As an alternative of step 302 for inserting a script, terminal 100 inserts the script 201 according to a predetermined criterion such as, for example, the address of the server 103.

According to another alternative of step 302, when the content 200 is divided into subpages, terminal 100 inserts script 201 into each subpage.

Then, terminal 100 sequentially executes the instructions present in content 200 into which a script was inserted.

Thus, during a step 304 for displaying the beginning of the page, the terminal 100 starts with executing the first instructions of the content, notably the instructions present in the header 202 and in the beginning of the body 203.

Then during a step 306, the terminal 100 interprets the script 201 (a script interpretation consists in translating the script which is written in a high level language which is not directly understandable by the terminal 100, into elementary actions without passing through machine code) and executes it e.g., for opening an alarm window and displaying a message.

According to an alternative of step 306, interpretation and execution of the script code are interrupted as soon as the user requests display of a new page of data.

According to the first alternative, described with reference to FIG. 2, the script code is not placed within the body 203 of the content 200 but in its header 202, or in the trailer 204. It may also be placed outside the HTML areas while remaining within the content 200 provided to terminal 100.

When the script code is placed in the header portion 202, or before the HTML area, the steps for interpreting 305 and for executing 306 the script, take place before the step 304 for displaying the beginning of the page (then merging with step 307 for displaying the end of the page).

A direct application of the first alternative is an application of the Web page censure type. According to this application, the script code is placed in the header portion 202, or before the HTML area, and it allows the whole or a portion of the data to be censured, which follow the script code in the content. The data may notably be censured (i.e. not displayed on the terminal 100 and/or made unavailable) if the user of the terminal 100 does not have the required authorizations for accessing the data.

When the script code is placed in the trailer portion 204, or after the HTML area, the steps for interpreting 305 and executing 306 the script take place after step 307 for displaying the end of the page 304 (then merging with step 304 for displaying the beginning of the page).

Thus, another direct application of the first alternative is an application of the annotation or complementary information type (such as notably advertising information) notably displayed after the data, upon completion of display of these data.

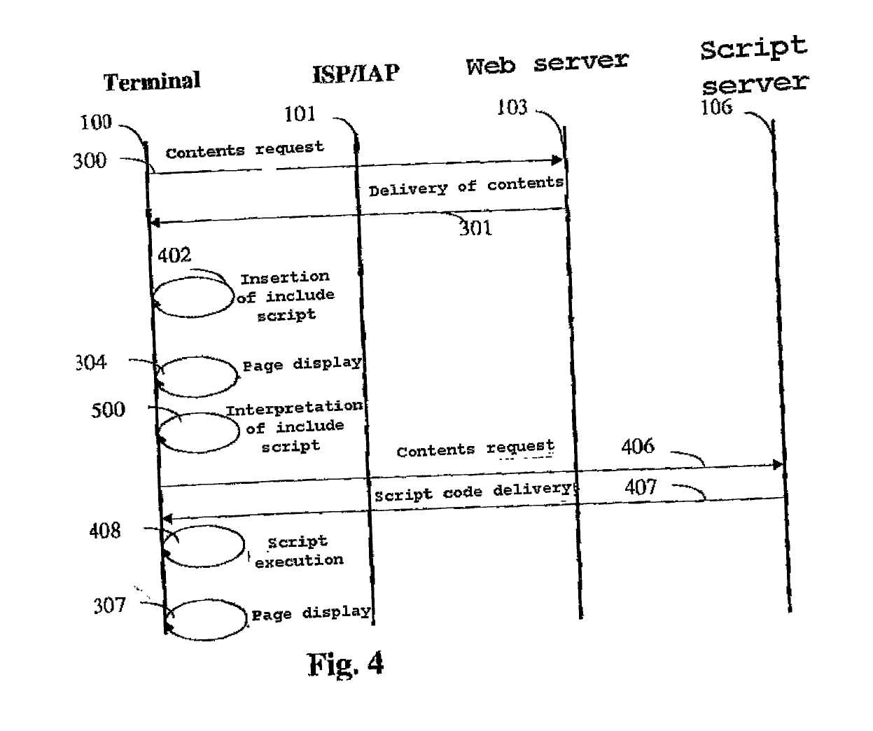

FIG. 4 shows an alternative of the communication protocol with insertion of an “include” of script code into a page of data by the terminal 100.

Subsequently to terminal 100 looking up 300 the site of server 103 via the access provider 101, server 103 delivers a content to the access provider 101 during a step for delivering content 301.

Then, during a step 402 for inserting an “include” of script code, the terminal 100 inserts an active code of the “include” type of script code.

The “include” of script code is inserted in a similar way to a script code 201 within a content 200.

As an alternative of step 402, terminal 100 inserts the “include” of script code 201 according to a predetermined criterion such as, for example, the address of the server 103.

According to another alternative of step 402, when the content 200 is divided into subpages, terminal 100 inserts the “include” of script code 201 into each subpage.

Then, during a step 304 for displaying the beginning of the page, terminal 100 sequentially executes the instructions present in the received content 200.

Thus, terminal 100 starts with executing the first instructions of the content notably the instructions present in the header 202 and in the beginning of the body 203.

Then, during a step 405, terminal 100 interprets the “include” of script code by decoding the instructions present in the “include” of script code.

Then, during a step 406 for requesting the content generated by the interpretation of the “include” of script code, terminal 100 send a request for a content to a script server at a URL address specified by the “include” of script code and corresponding to the script server 106.

Thus, if for example, the “include” script is the following;

<script src=“http://www.mysite.com/myscript.js”></script>, terminal 100 sends a request for the script “myscript.js” to script server “www.mysite.com”.

According to an alternative of step 406, execution of the “include” of script code is interrupted as soon as the user requests that a new page of data be displayed.

Then, during step 407, the script server 106 delivers a script code (“myscript.js” according to our example) to terminal 100.

Then, during a step 408, terminal 100 writes the content of the script (“myscript.js” here) sent back by the script server into its memory, interprets it and executes it. Execution of the received script code consists, for example, of opening an alert window containing a message.

Then, during a step 307, the terminal executes the instructions which follow the “include” of script code in the delivered content 202, notably instructions present in the end of the body 203 and in the trailer 204 of the content.

According to a first alternative described with reference to FIG. 2, the active code is not placed within the body 203 of contents 200 but in its header 202, or in the trailer 204. It may also be placed outside the HTML areas while remaining within the content provided to terminal 100.

When the “include” of script code is placed in the header portion 202, or before the area HTML, step 405 for interpreting the “include” of script, step 406 for requesting the content, step 407 for delivering the script code and step 408 for interpreting and executing the script code take place before step 304 for displaying the beginning of the page (then merging with step 307 for displaying the end of the page).

A direct application of the first alternative is an application of the Web page censure type quite similar to the application of the censure type described with reference to FIG. 3.

When the “include” of script code is placed in the trailer portion 204, or after the HTML area, step 405 for interpreting the “include” of script, step 406 for requesting the content, step 407 for delivering the script code and executing the script code 408 take place after step 307 for displaying the end of the page (then merging with step 304 for displaying the beginning of the page).

Another direct application of the first alternative is an application of the annotation or complementary information type (such as notably advertising information) displayed after the data upon completion of the display of these data, quite similar to that described with reference to FIG. 3.

It is thus noted that FIGS. 3 and 4 describe two complementary embodiments of the invention: according to FIG. 3, terminal 100 directly inserts script code within the data whereas according to FIG. 4, terminal 100 inserts an “include” of script code which will be used by the terminal for requesting a content itself containing a script code.

Subsequently, two applications will be described. According to a preferred embodiment, both of these applications are based on the alternative protocol described with reference to FIG. 4, but they may also be implemented according to the preferred embodiment of the protocol described with reference to FIG. 3.

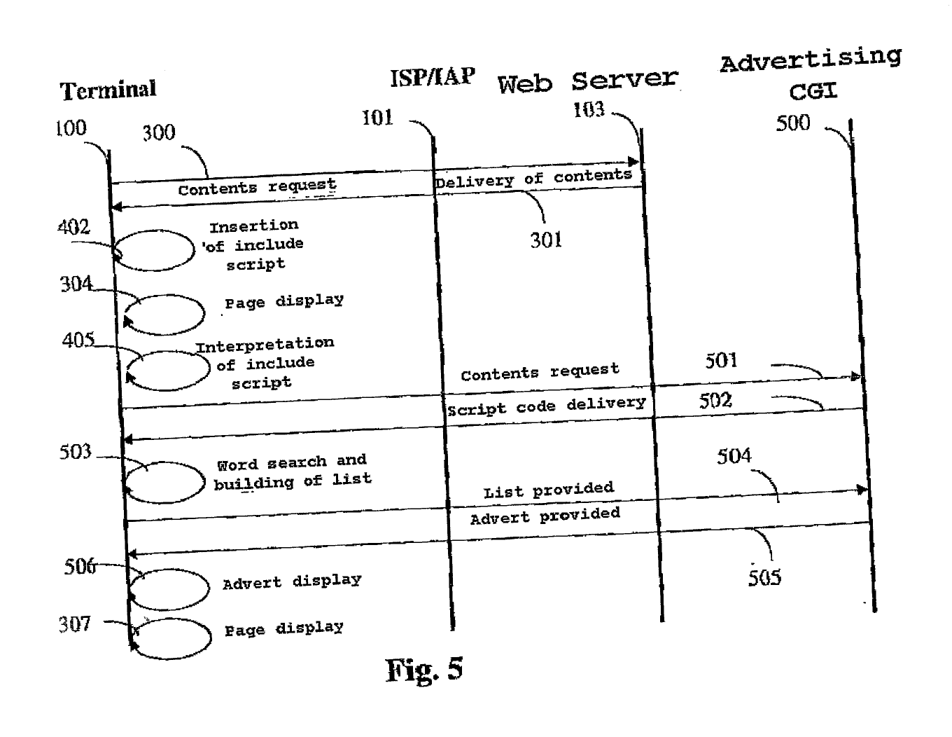

FIG. 5 shows a communications protocol for an application of the advertising insertion type for which first steps 300, 301, 402, 403 and 304 are identical with the first steps of the protocol described with reference to FIG. 4, except for the fact that during step 402 for inserting the “include” of script code, terminal 100 inserts an “include” of specific script code, the final purpose of which is to deliver complementary, notably advertising information. As the first steps of FIG. 5 are similar to the first steps of FIG. 4, they bear the same reference numbers and will not be described further.

Subsequently to step 304, for displaying the beginning of the page, during a step 500 for interpreting the received “include” of script code, terminal 100 interprets this “include” by decoding the instructions present within the “include” of script code.

Then, during a step 501 for requesting a content, the terminal sends a request for a content to a server, the URL address of which was specified in the received “include” of script code, for example here, the address of the CGI advertising type server 500.

Next, during a step 502, server 500 delivers the specified contents to terminal 100. This content notably contains an active code for a semantic search, notably through keywords, in the data displayed on the screen of terminal 100. This active code is a script code here. However, as an alternative, this active code may assume all the forms of active code already described with reference to the description of the general principle of the invention.

Then, during a step 503 for a semantic search, terminal 100 executes the active code. This execution consists in searching for specific pieces of information present in the page displayed on the screen and in building a list of the specific pieces of information found; these specific pieces of information are notably keywords, link addresses, addresses of items mentioned in the downloaded page and information for creating the downloaded page such as its author, the creation date and the company to which belongs its author. The sought-after specific information is updated according to a predetermined criterion and notably depends on one or more criteria notably including the identity of the user of the terminal 100, his/her preferences, the address and/or the name of the domain of the remote site which has provided the content 200, the type and/or the version of the navigator used by the terminal 100, the type and/or the version of terminal 100, the transfer protocol used for downloading the downloaded content 200 and the access provider enabling the terminal 100 to access the content sites.

Next, during a step 504, the terminal 100 provides the list built from the specific pieces of information, to the server 500.

Then, during a step 505, the server 500 analyzes the list of specific information found, which it has received from terminal 100, determines an advertisement (or several advertisements if necessary) adapted to this list and provides them to terminal 100. Thus, the provided advertising is highly targeted.

Then, during a step 506, the terminal 100 displays the advertisement received from server 500 (or the received advertisements if necessary).

Then, during a step 307, the terminal executes the instructions which follow the “include” of script code in the delivered content 202, notably instructions present in the end of the body 203 and in the trailer 204 of the content.

According to the first alternative described with reference to FIG. 2, the active code is not placed within the body 203 of content 200, but in its header 202 or in the trailer 204. It may also be placed outside the HTML areas while remaining within the content provided to terminal 100.

The case when the active code is placed at the end of the body 203, in the trailer portion 204 of HTML code or after this portion 204 while remaining in the content 200 is particularly of interest as in this case, the whole downloaded page is displayed when the semantic search on this page is performed during step 503.

According to another alternative, the semantic search operation 503 is used for applications of the information insertion type (such as notably links to Internet sites, annotations, . . . ) relating to the results of the semantic search (i.e., for example, in the same field as one or several items from the list of specific information, from the semantic search, or a neighboring or resulting field), this information is not necessarily advertising information.

According to an alternative of step 503, the semantic search is performed not only on the page data displayed on the screen, but on the whole downloaded content 200. The result of the semantic search may then be used by many types of applications, notably censure applications (as described with reference to FIG. 3), applications changing the presentation of the data, and/or applications for inserting additional data.

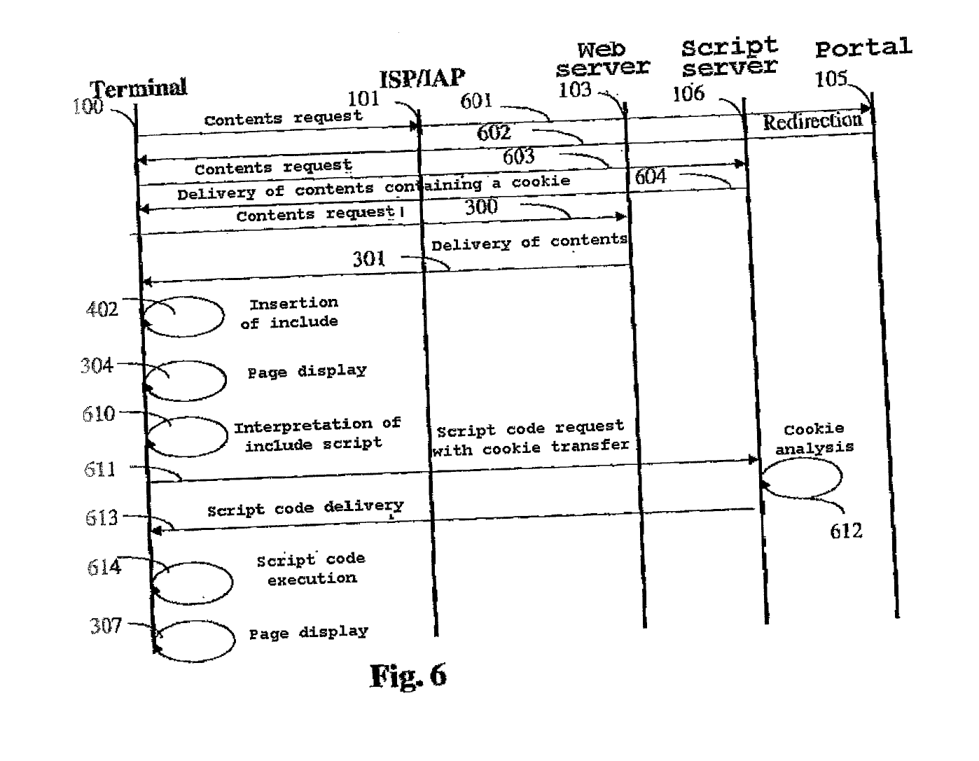

FIG. 6 shows a communications protocol for an application of the application type for permanently providing an Internet service.

During step 601 for requesting a content, the terminal sends a request for a content to a server 105 of the portal type.

Then, during a redirection step 602, the server 105 indicates to the terminal 100, a URL address which the terminal 100 should access.

Then, during a step 603, the terminal 100 accesses the URL address of the script server 106, specified by the server 105 and requests a content.

Next, during a step 604, after a step for defining a profile of the user of terminal 100 (the user of terminal 100 for example having answered a questionnaire or having filled an online form), the server 106 delivers to terminal 100, a content which contains a customized cookie specific to the user of terminal 100 and depending on the profile of the user. For instance, one may thus have a cookie specifying the name of the user: “NameoftheClient=firstname.name” and more generally a profile specifying the preferences of the user. During this step 604, after delivering the customized cookie, the terminal 100 stores this cookie in memory which is connected with the server 106, and it may accompany every subsequent request for content to the server 106 by terminal 100.

Then, steps 300, 301, 402 and 304 follow, identical with the first steps of the protocol described with reference to FIG. 4, except for the fact that during step 402 for inserting the “include” of script code, terminal 100 inserts a particular “include” of script code, the final purpose of which is to provide a script code taking into account a delivered cookie, connected with the script server 106. As these steps are similar to the first steps of FIG. 4, they bear the same reference numbers and will not be described further.

Subsequently to step 304 for displaying the beginning of page, during a step 610 for interpreting the received “include” of script code, terminal 100 interprets this “include” by decoding the instructions present in the “include” of script code.

Then, during a step 611, terminal 100 sends a request for a content to the script server 106, by transferring the cookie present on terminal 100, connected with server 106 and delivered during step 604.

Then, during a step 612, the server 106 analyses the received cookie in order to deliver a final script code adapted to the needs of the user of terminal 100 Thus, if the cookie contains a user profile identifying the user and/or indicating for example his/her preferences in an encoded format, server 106 generates a customized script code adapted to the profile of the user.

Next, during a step 613, the server 106 delivers to terminal 100, a code script such as determined by the server 106 during step 612. Terminal 100 then retains the script code in memory.

Then, during a step 614, terminal 100 executes the received script code which consists in associating a function present in the script with an event from the event manager present in the navigator of the terminal, (as for example, hitting a key of the keyboard, an action on the mouse associated with the terminal, such as a right click (or in other terms, hitting the right button of the mouse), a combined action on the keyboard and the mouse or a navigation event).

Thus, for example, a function for displaying a menu notably enabling access to services provided by the script server 106, may be associated with a right click of the mouse. One or several services are thus declared which become accessible by a mere right click of the mouse.

These services are notably:

simplified services for accessing information other than that contained in content 200;

simplified services for accessing search engines;

simplified services for accessing advance functions of a navigator comprised in terminal 100;

services for monitoring external events; and

simplified accesses to at least one service available by hand on the Internet and which requires at least that data be entered.

Then, during a step 307, the terminal executes the instructions which follow the “include” of script code in the delivered content 202, notably the instructions present in the end of the body 203 and in the trailer 204 of the content.

During or subsequently to step 307, during a step 615, every time the user of terminal 100 clicks the right button of the mouse under the navigator application, a script code function for displaying a menu will be executed, the event manager of the navigator having associated this function with the action of a right click. The user may then select an item of the menu displayed which will notably enable him/her to access a service provided by the script server 106.

As an alternative of step 615, the user may then select an icon which will have been declared and displayed beforehand by the active code, which enables him/her to access a service provided by the script server 106. It is noted that the event manager of the navigator provides access to the service by associating this access function with the action of selecting the icon.

As an alternative, the script delivered by the script server 106 during step 613 comprises a function (as e.g. for displaying a menu) which is executed without it being necessary to associate an event therewith.

The described embodiments do not have the purpose of reducing the field of the invention. Accordingly, many modifications may be made to it without departing from the scope of the latter; notably the case may be contemplated when the inserted active code is not a JavaScript code or an “include” of script code interpreted by a navigator.

Thus, the invention also relates to the case when the active code is:

a script (not necessarily a JavaScript);

a navigator object;

a code exploiting a navigator object

an applet;

a code exploiting an applet; and/or

a macro-instruction

The invention also relates to the case when the active code comprises at least one type of codes among the aforementioned codes notably including scripts, “includes” of script code, navigator objects, applets, codes exploiting navigator objects or applets and macro-instructions.

ActiveX® codes are generally inserted into a content, delimited by markers <object> and </object>.

Applet codes are inserted into a content, delimited by markers <applet> and </applet>.

Further, the invention is not limited to the case when a single script code is inserted into a content on the fly, but is applied to the case when several script codes are inserted into a content on the fly, these script codes may be of a same type or not, dependent or not. (Moreover, ActiveX® and applet type codes generally require a script code in order to be used).

Thus, two active codes may for example, be inserted in a content enabling an application of the union type to be used on Internet, one of the codes being of the ActiveX® type (<Object ID=Netmeeting CLASSID=“CLSID identifier”><PARAM NAME=“MODE” VALUE=“telephone”>) and the other of the script code type performing the call (<script language=“javascript1.2”>Netmeeting.CallTo(“callto;0171000803+gateway=195.115.183.1+type=phone”);</script>).

Moreover, the invention is not limited to the case when the active code inserted on the fly is generated according to the data of the downloaded page, but it extends to the case when the active code inserted on the fly is generated according to any criterion such as notably, the user(s) of the terminal 100, the terminal 100 itself, the site providing the data. During the operation for generating the inserted script code, one or several criteria may be taken into account, notably the identity of the user(s) of the terminal 100, his/her/their preferences, the address and/or the name of the domain of the distant site which has provided the downloaded data on terminal 100, the address of the downloaded page, the type and/or the version of the navigator used by the terminal, the type and/or the version of the terminal 100, the transfer protocol used for downloading the downloaded page 200.

Further, the invention is not limited to the case when the data are looked up from a network but it extends to the case when data are available on a data medium such as notably a diskette, a CD-ROM, a DVD-ROM and are read by the terminal.

1. A method for optimizing the looking up of a page of data looked up on a terminal by at least one user, the looked-up data being downloaded from a first remote site and/or available on a data medium,
characterized in that it comprises a step for inserting on the fly at least one active code into said page by said terminal.

2. The optimization method according to claim 1, characterized in that the area of said page wherein said active code is inserted, is determined according to the type of action generated by said active code.

3. The optimization method according to claim 1, characterized in that said active code inserted on the fly is a final active code enabling an algorithm to be executed on said terminal.

4. The optimization method according to claim 1, characterized in that said active code inserted on the fly is an intermediate invocation active code which, when it is executed by said terminal, enables said terminal to invoke a provider of final active code, so that the terminal receives from the latter a final specific active code enabling an algorithm to be executed on said terminal.

5. The optimization method according to claim 4, characterized in that, during said invocation of the final active code provider by said terminal, said terminal further provides at least one cookie.

6. The optimization method according to claim 5, characterized in that it further comprises at least one step preceding said step for insertion on the fly and belonging to the group comprising:
the steps for defining a profile for a user of said terminal,
the steps for generating said at least one cookie depending on said profile for a user of said terminal,
the steps for providing said at least one cookie by said final active code provider to said terminal, and
the steps for storing said at least one cookie by said terminal.

7. The optimization method according to claim 5, characterized in that said at least one cookie is used for identification purposes.

8. The optimization method according to claim 5, characterized in that said final active code provider takes the content of said at least one cookie into account for generating said specific final active code.

9. The optimization method according to claim 1, characterized in that said active code belongs to the group comprising:
script codes interpreted by a navigator,
“includes” of script code interpreted by a navigator,
navigator objects,
codes exploiting navigator objects,
applets,
codes exploiting applets, and
macro-instructions.

10. The optimization method according to claim 1, characterized in that said active code inserted into said page is loaded and/or interpreted and/or executed by said terminal before, during and/or after displaying said page on said terminal.

11. The optimization method according to claim 1, characterized in that said active code is executed in a navigator comprised in said terminal.

12. The optimization method according to claim 1, characterized in that said active code is specifically generated according to at least one criterion specific to a component belonging to the group comprising:
said at least one user of said terminal,
said terminal,
said first remote site,
said page,
the Internet access provider enabling said terminal to access said first
remote site, and
the navigator used by said terminal.

13. The optimization method according to claim 12, characterized in that said at least one criterion belongs to the group comprising:
the identity of said at least one user of said terminal,
the preferences of said at least one user of said terminal,
the address and/or the name of the domain of the first remote site,
the origin of said looked-up data,
the type and/or the version of the navigator used by said terminal,
the type and/or the version of said terminal,
the provider of said looked-up data, and
the type of access to said looked-up data.

14. The optimization method according to claim 1, characterized in that, it is used for at least one application belonging to the group:
insertion into said page, of information
insertion into said page, of information relating to events handled by a second remote site connected to said terminal,
insertion into said page of information relating to data available on a portal related to the content of said page,
provision to the user, via said page, of at least one service provided by at least one third remote site connected to said terminal,
archiving of information related to the activity of the user of said terminal,
change in the presentation of said data,
censure of at least one datum among said data, and
invocation of at least one second active code.

15. The optimization method according to claim 14, characterized in that it is used for at least one application of the type for inserting into said page, additional information,
and in that said active code implements the following operations:
search for at least one specific piece of information in said page,
creation of a list of specific pieces of information found in said page,
creation of an area for inserting additional information in said page,
provision of said list of specific pieces of information to a provider of additional information connected to said network, and
filling said area for inserting additional information, with data provided by said information provider in response to said operation for providing said list of specific pieces of information.

16. The optimization method according to claim 15, characterized in that said additional pieces of information belong to the group comprising:
advertising information,
annotations,
complementary links to remote sites dealing with the same subject as said looked-up data,
complementary links to remote sites dealing with subjects related to the subject of said looked-up data,
alternative keywords,
notes assigned to said first remote sites, and
tables for indexing the items of said page of looked-up data.

17. The optimization method according to claim 14, characterized in that it is used for at least one application for changing the presentation of said data;
and in that said active code implements the following operations:
search for at least one specific piece of information in said page,
creation of a list of specific pieces of information found in said page,
provision of said list of specific pieces of information to an information provider connected to said terminal, and
presentation of at least one portion of said downloaded data according to a format defined by said information provider (106) in response to said operation for providing said list of specific pieces of information.

18. The optimization method according to claim 14, characterized in that it is used for at least one application for censuring at list one datum among said data,
and in that said active code implements the following operations:
search for at least one specific piece of information in said page,
creation of a list of specific pieces of information found in said page,
provision of said list of specific pieces of information to an information provider connected to said network, and
censure of at least one portion of said data according to at least one criterion defined by said information provider in response to said operation for providing said list of specific pieces of information.

19. The optimization method according to claim 14, characterized in that it is used for at least one application for invoking at least one second active code,
and in that said active code implements the following operations:
creation of a list of specific pieces of information found in said page,
provision of said list of specific pieces of information to an information provider connected to said terminal, and
invocation of at least one second active code according to at least one criterion defined by said information provider in response to said operation for providing said list of specific pieces of information.

20. The optimization method according to claim 15, characterized in that said at least one specific piece of information belongs to the group of information comprising:
keywords,
link addresses,
addresses of items mentioned in said page, and
information for creating said page.

21. The optimization method according to claim 15, characterized in that said at least one specific piece of information is updated according to a predetermined criterion.

22. The optimization method according to claim 21, characterized in that said predetermined criterion belongs to a group of criteria comprising:
the identity of said at least one user of said terminal,
the preferences of said at least one user of said terminal,
the address and/or the name of the domain of said first remote site,
the origin of said looked-up data,
the type and/or the version of the navigator used by said terminal,
the type and/or the version of said terminal,
the provider of said looked-up data,
the type of access to said looked-up data, and
the Internet access provider enabling said terminal to access said first remote site.

23. The optimization method according to claim 14, characterized in that it is used for at least one application of the type for permanently providing the user, via said page, with at least one service provided by at least one fourth remote site connected to said network,
and in that said active code, when it is executed by said terminal, declares said at least one service in said page.

24. The optimization method according to claim 23, characterized in that said code enables a menu for accessing at least one service to be implemented by the terminal.

25. The optimization method according to any of claims 23 and 24, characterized in that said at least one service belongs to the group comprising:
simplified services for accessing information other than that contained in said page,
simplified services for accessing search engines,
simplified services for accessing advanced functions of a navigator comprised in the terminal,
services for monitoring external events, and
simplified access to at least one service available by hand on the Internet and which requires at least that data be entered.

26. The optimization method according to claim 23, characterized in that said at least one service is attached to at least one event belonging to the group comprising:
actions on a man-machine interface, and
navigation events.

27. The optimization method according to claim 23, characterized in that said at least one service is attached to at least one marked-up language item.

28. The optimization method according to claim 1, characterized in that said page of data consists of at least two subpages, wherein said active code is included in each said subpage.

29. A system characterized in that it comprises means adapted for implementing active code insertion according to claim 1.

30. A device for optimizing the lookup of a page of data looked up on said device by at least one user, the looked-up data being downloaded from a first remote site and/or available on a data medium
characterized in that it comprises means for inserting on the fly at least one active code into said page.

31. The optimization device according to claim 30, characterized in that it belongs to the group comprising:
microcomputers,
terminals for looking up data on a network,
terminals for looking up data from a removable medium, and
mobile terminals.
